(19) United States
(12) Patent Application Publication
(10) Pub. No.: US 2022/0403668 A1
(43) Pub. Date: Dec. 22, 2022

(54) WOOD FLOOR WITH FRAME STRUCTURE

(71) Applicant: Sai York HUNG, HongKong (CN)

(72) Inventor: Sai York HUNG, HongKong (CN)

(21) Appl. No.: 17/378,804

(22) Filed: Jul. 19, 2021

(30) Foreign Application Priority Data
Jun. 18, 2021 (CN) 202121362538.9

(51) Int. Cl. E04F 15/04; B32B 21/14; B32B 3/30; B32B 3/14; B32B 21/13

(52) U.S. Cl. CPC E04F 15/045; B32B 21/14; B32B 3/30; B32B 3/14; B32B 21/13; B32B 2419/04

(57) ABSTRACT

A wooden floor with a frame structure is disclosed, which can reduce the internal stress, prevent the deformation of the floor, improve the overall stability and firmness of the floor, effectively reduce the use of adhesive in the production process, reduce the release of formaldehyde, and make the living environment safer. The wood floor with the frame structure includes a core board and a veneer. The long side of the core board is clamped by a left slat and a right slat, and the veneer is covered on the core board, the left slat and the right slat. The surface of the core board contacting with the veneer is a front side and the other side is a back side. A plurality of notches are opened on the front or back side of the core board, and the notches are perpendicular to the left slat and the right slat.

### CROSS REFERENCE TO THE RELATED APPLICATIONS

This application is based upon and claims priority to Chinese Patent Application No. 202121362538.9, filed on Jun. 18, 2021, the entire contents of which are incorporated herein by reference.

### TECHNICAL FIELD

The present invention relates to the technical field of wood floor, and particularly to wood floor with frame structure.

### BACKGROUND

With the improvement of people's living standards, more and more people pay more attention to the quality of life, hoping to make the room comfortable and livable. Wood floor and ceramic tile are commonly used floor decoration materials. Compared with ceramic tile, wood floor has no radiation, better environmental protection performance, lower transportation and installation costs, and is more anti-skid, with less damage after sliding. Therefore, the wood floor becomes the most preferred floor decoration material. At present, the composite wood floor is generally made of several boards, and its internal stress is very large, which seriously affects the overall stability of the floor, and is easy to cause deformation. And once slotted in the interior, it is easy to cause plate cracking, greatly reducing the firmness of the composite wood floor.

### SUMMARY

The technical problem addressed by the present invention is to overcome the deficiency in the prior art, the technical problem to be solved by the present invention is to provide a wooden floor with a frame structure, which can reduce the internal stress, prevent the deformation of the floor, improve the overall stability and firmness of the floor, effectively reduce the use of adhesive in the production process, reduce the release of formaldehyde, and make the living environment safer.

The technical scheme of the present invention is as follows: the wood floor with the frame structure includes a core board (1) and a veneer (2), the long side of the core board is clamped by a left slat (3) and a right slat (4), the veneer is covered on them, the surface of the core board contacting with the veneer is a front side and the other side is a back side, and a plurality of notches (5) are opened on the front or back side of the core board, and the notches are perpendicular to the left slat and the right slat.

The long side of the core board of the present invention is clamped by the left and right strip plates, and the wood veneer is covered on them, so as to reduce the internal stress and improve the overall stability of the floor. There are several notches on the front or back of the core board, and the notches are perpendicular to the left and right slats, so as to prevent the deformation of the floor and improve the firmness of the floor. Because the long side of the core board is clamped by the left and right strips, the usage of adhesive in the production process is effectively reduced, the formaldehyde emission is reduced, and the living environment is safer.

### BRIEF DESCRIPTION OF THE DRAWINGS

FIG. 1 shows the structural schematic diagram of the first embodiment of the wooden floor with the frame structure according to the present invention.

FIG. 2 shows the structural schematic diagram of the second embodiment of the wooden floor with the frame structure according to the present invention.

FIG. 3 shows the structural schematic diagram of the third embodiment of the wooden floor with the frame structure according to the present invention.

FIG. 4 shows the structural schematic diagram of the fourth embodiment of the wooden floor with the frame structure according to the present invention.

FIG. 5 shows the structural schematic diagram of the fifth embodiment of the wooden floor with the frame structure according to the present invention.

FIG. 6 shows the structural schematic diagram of the sixth embodiment of the wooden floor with the frame structure according to the present invention.

FIG. 7 shows the structural schematic diagram of the seventh embodiment of the wooden floor with the frame structure according to the present invention.

FIG. 8 shows the structural schematic diagram of the eighth embodiment of the wooden floor with the frame structure according to the present invention.

FIG. 9 shows the structural schematic diagram of the ninth embodiment of the wooden floor with the frame structure according to the present invention.

FIG. 10 shows the structural schematic diagram of the tenth embodiment of the wooden floor with the frame structure according to the present invention.

FIG. 11 shows the structural schematic diagram of the eleventh embodiment of the wooden floor with frame structure according to the present invention.

FIG. 12 shows the structural schematic diagram of the twelfth embodiment of the wooden floor with the frame structure according to the present invention.

FIG. 13 shows the structural schematic diagram of the thirteenth embodiment of the wood floor with the frame structure according to the present invention.

FIG. 14 shows the structural schematic diagram of the fourteenth embodiment of the wood floor with the frame structure according to the present invention.

FIG. 15 shows the structural schematic diagram of the 15th embodiment of the wooden floor with the frame structure according to the present invention.

FIG. 16 shows the structural schematic diagram of the sixteenth embodiment of the wooden floor with the frame structure according to the present invention.

### DETAILED DESCRIPTION OF THE EMBODIMENTS

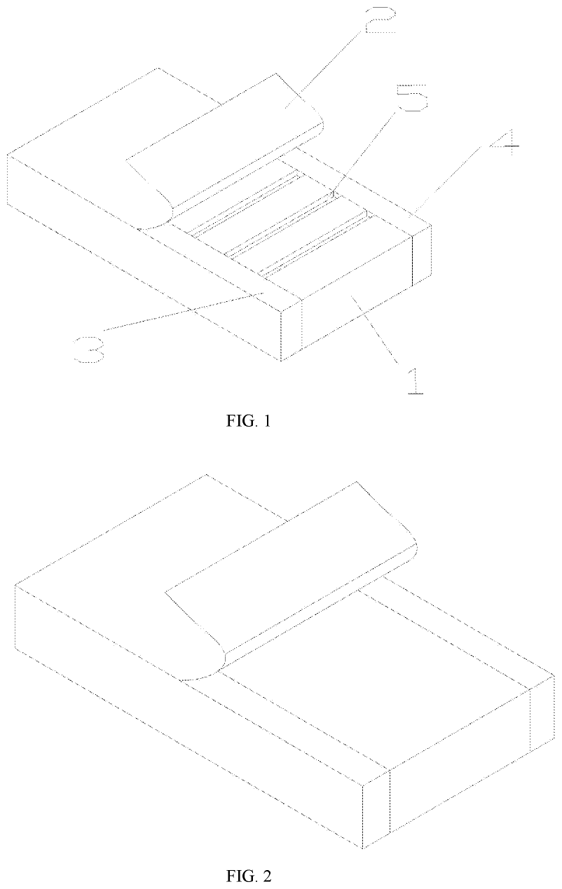

As shown in FIGS. 1 and 2, the wood floor with frame structure includes a core board 1 and a veneer 2, the long side of the core board is clamped by the left slat 3 and the right slat 4, and the veneer is covered on them, the surface of the core board contacting with the veneer is the front side and the other side is the back side, and there are several notches on the front or back side of the core board (FIG. 1 shows the notches on the front side and FIG. 2 shows the notches on the back side). The notch is vertical to the left and right slats.

The long side of the core board of the present invention is clamped by the left and right strip plates, and the wood veneer is covered on them, so as to reduce the internal stress and improve the overall stability of the floor. There are several notches on the front or back of the core board, and the notches are perpendicular to the left and right slats, so as to prevent the deformation of the floor and improve the firmness of the floor. Because the long side of the core board is clamped by the left and right strips, the usage of adhesive in the production process is effectively reduced, the formaldehyde emission is reduced, and the living environment is safer.

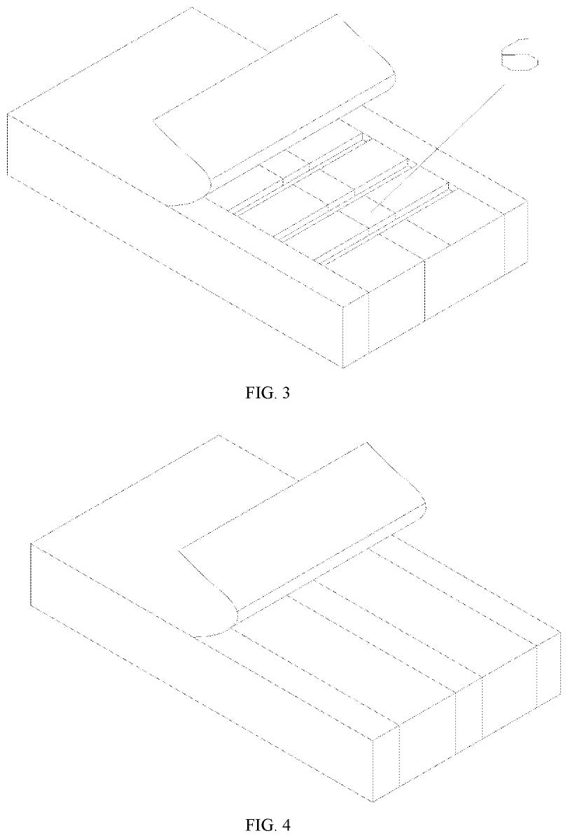

Preferably, as shown in FIGS. 3 and 4, the core board is divided into left and right plates, and a middle strip 6 is arranged between the left and right plates. The purpose of adopting such a structure is to better prevent the deformation of the floor and improve the firmness of the floor.

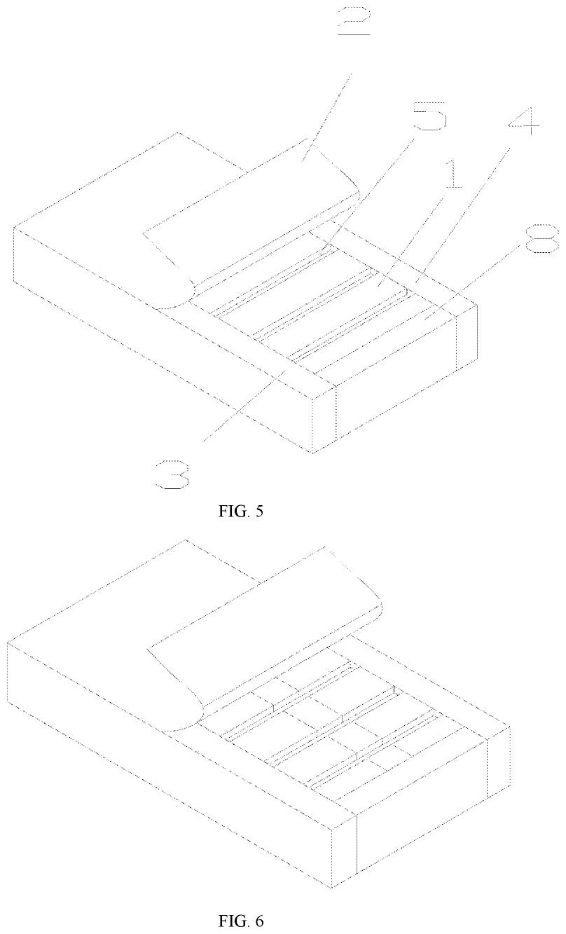

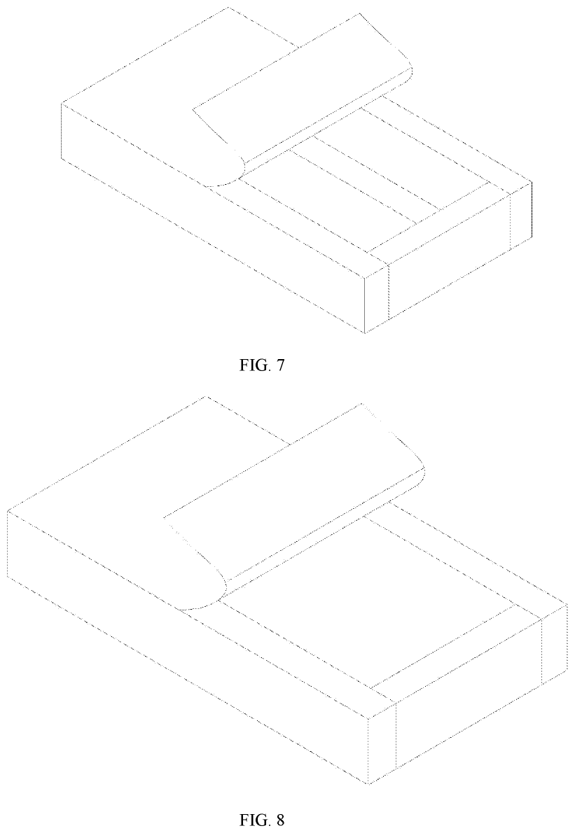

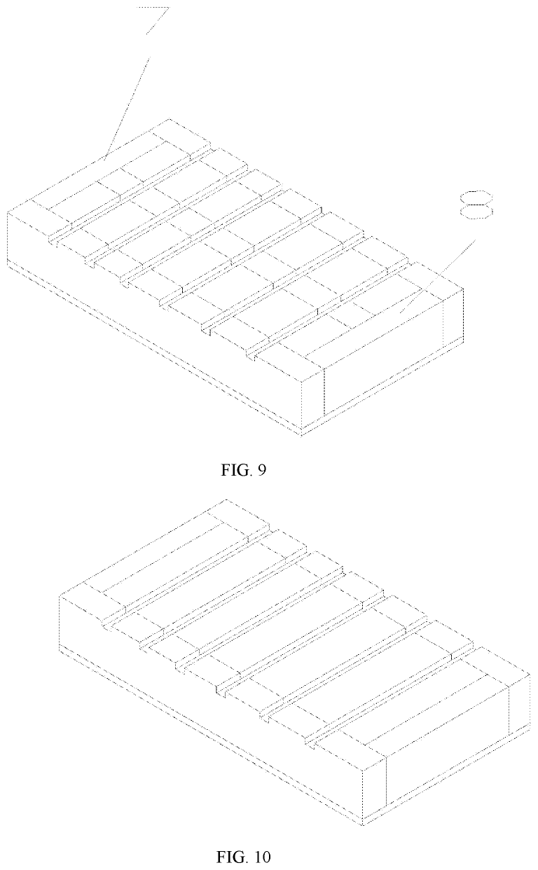

Preferably, as shown in FIG. 9, the upper strip 7 and the lower strip 8 are respectively arranged on the short side of the core board, and FIGS. 5-8 show that the upper strip and the lower strip are covered with wood veneer. FIG. 9 and FIG. 10 are to show the upper strip 7 and the lower strip 8 more clearly, without wood veneer. The actual product is covered with wood veneer. Setting up four borders can better prevent the floor from deformation and improve the firmness of the floor.

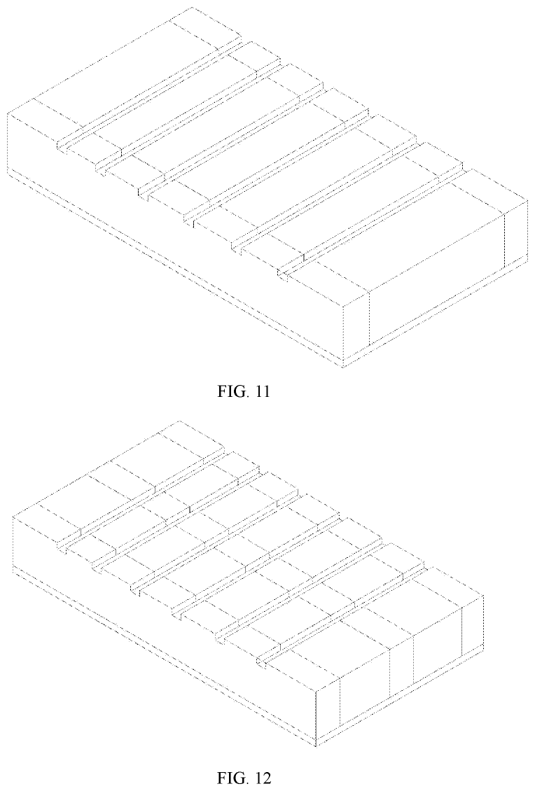

Preferably, as shown in FIGS. 9-12, the notch crosses the left and right slats. This can further reduce the internal stress and improve the overall stability of the floor.

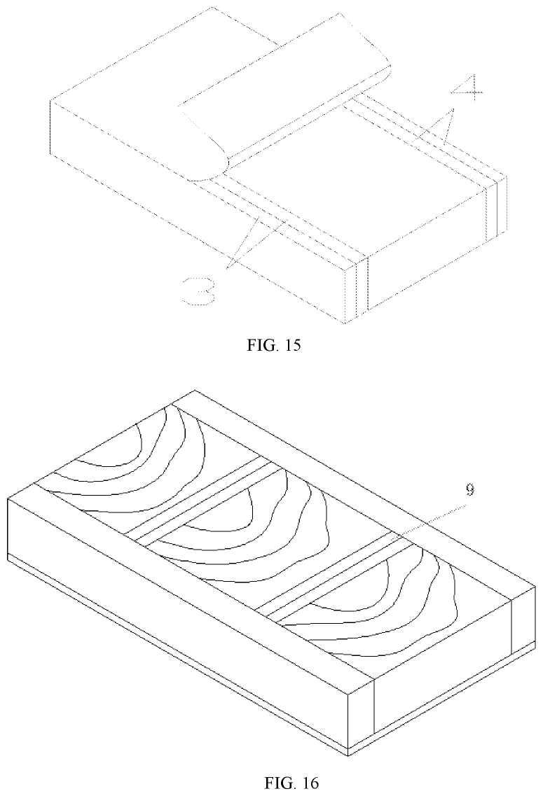

Preferably, as shown in FIG. 15, the number of the left slats 3 and the right slats 4 is two. This can further prevent the deformation of the floor and improve the firmness of the floor.

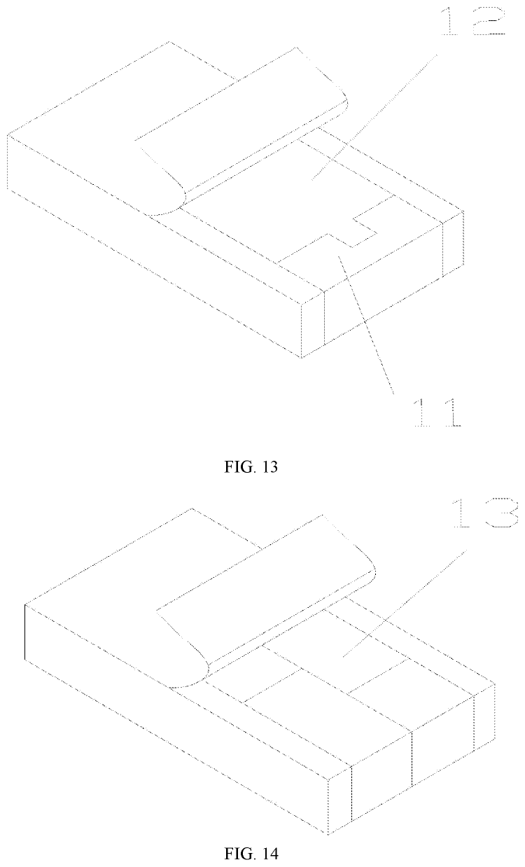

Preferably, as shown in FIG. 13, the core board is clamped together by a plurality of concave plates 11 and convex plates 12. The purpose of adopting such a structure is to better prevent the deformation of the floor and improve the firmness of the floor.

Or, as shown in FIG. 14, the core board is spliced by several rectangular plates 13. Preferably, as shown in FIG. 16, a cross bar 9 is arranged between the rectangular plates of the core board, which can further improve the overall stability of the floor.

The above contents are only the preferable embodiments of the present invention, and do not limit the present invention in any manner. Any improvements, amendments and alternative changes made to the above embodiments according to the technical spirit of the present invention shall fall within the claimed scope of the present invention.

What is claimed is:

1. A wood floor with a frame structure, comprising a core board and a veneer, wherein a long side of the core board is clamped by a left slat and a right slat; the veneer is covered on the core board, the left slat and the right slat; a first side of the core board is in contact with the veneer, and the first side of the core board is a front side; a second side of the core board is a back side; a plurality of notches are opened on the front side or the back side of the core board; and the plurality of notches are perpendicular to the left slat and the right slat.

2. The wood floor with the frame structure according to claim 1, wherein
the core board is divided into a left plate and a right plate, and a middle strip is arranged between the left plate and the right plate.

3. The wood floor with the frame structure according to claim 1, wherein
an upper strip and a lower strip are respectively arranged on short sides of the core board, and the upper strip and the lower strip are covered by the veneer.

4. The wood floor with the frame structure according to claim 3, wherein
the plurality of notches cross the left slat and the right slat.

5. The wood floor with the frame structure according to claim 1, wherein
the plurality of notches cross the left slat and the right slat.

6. The wood floor with the frame structure according to claim 1, wherein
a number of each of the left slat and the right slat is two.

7. The wood floor with the frame structure according to claim 1, wherein
the core board is clamped together by a plurality of concave plates and convex plates.

8. The wood floor with the frame structure according to claim 1, wherein
the core board is spliced by a plurality of rectangular plates.

9. The wood floor with the frame structure according to claim 8, wherein
a transverse bar is arranged between the plurality of rectangular plates of the core board.

10. The wood floor with the frame structure according to claim 2, wherein
an upper strip and a lower strip are respectively arranged on short sides of the core board, and the upper strip and the lower strip are covered by the veneer.

11. The wood floor with the frame structure according to claim 2, wherein
the plurality of notches cross the left slat and the right slat.
